(19) United States
(12) Patent Application Publication
(10) Pub. No.: US 2018/0180132 A1
(43) Pub. Date: Jun. 28, 2018

(54) MONO-TUBE SHOCK ABSORBER

(71) Applicant: KYB Corporation, Tokyo (JP)

(72) Inventors: Yasunori KOBAYASHI, Gifu (JP); Kazunori MASUMOTO, Gifu (JP); Takao MURATA, Gifu (JP); Kazuyuki MAMIYA, Gifu (JP)

(73) Assignee: KYB Corporation, Tokyo (JP)

(21) Appl. No.: 15/738,283

(22) PCT Filed: Jun. 8, 2016
(86) PCT No.: PCT/JP2016/067094

§ 371 Date: Dec. 20, 2017

(30) Foreign Application Priority Data
Jul. 14, 2015 (JP) 2015-140625

(51) Int. Cl. F16F 9/06; F16F 9/32

(52) U.S. Cl. CPC F16F 9/06; F16F 9/36; F16F 9/32

(57) ABSTRACT

A mono-tube shock absorber includes a cylinder, a piston slidably inserted into the cylinder, a piston rod coupled to the piston, an upper component group detachably attached to an end portion at a side of an extension-side chamber of the cylinder, a tube that is disposed inside a contraction-side chamber and has one end secured to an end portion at a side of the contraction-side chamber of the cylinder, a valve mechanism detachably attached to the other end side of the tube to partition a reservoir inside the tube, and a free piston that partitions the reservoir into a liquid chamber and a gas chamber.

### TECHNICAL FIELD

The present invention relates to a mono-tube shock absorber.

### BACKGROUND ART

JP2010-60083A discloses a mono-tube shock absorber where a valve mechanism is attached to a tube disposed inside a contraction-side chamber to partition a reservoir inside the tube. The reservoir is partitioned into a liquid chamber and a gas chamber by a free piston inserted into the tube.

### SUMMARY OF INVENTION

The mono-tube shock absorber disclosed in JP2010-60083A has a problem that tuning of damping force and an overhaul cannot be performed by disassembly since respective components are mounted by welding or crimping.

An object of the present invention is to ensure disassembly of a mono-tube shock absorber where a valve mechanism is attached to a tube disposed inside a contraction-side chamber.

According to one aspect of the present invention, a mono-tube shock absorber includes a cylinder in which operating fluid is sealed, a piston slidably inserted into the cylinder, the piston partitioning an inside of the cylinder into an extension-side chamber and a contraction-side chamber, a piston rod movably inserted into the cylinder, the piston rod being coupled to the piston, an upper component group that includes at least an oil seal and a rod guide, the upper component group being detachably attached to an end portion at the extension-side chamber side of the cylinder, a tube disposed inside the contraction-side chamber, the tube having one end secured to an end portion at the contraction-side chamber side of the cylinder, a valve mechanism detachably attached to the other end side of the tube, the valve mechanism partitioning a reservoir inside the tube, and a free piston slidably inserted into the tube, the free piston partitioning the reservoir into a liquid chamber and a gas chamber.

### BRIEF DESCRIPTION OF DRAWINGS

FIG. 1 is a cross-sectional view of a mono-tube shock absorber according to an embodiment of the present invention.

### DESCRIPTION OF EMBODIMENTS

The following describes a mono-tube shock absorber (hereinafter referred to as a shock absorber) 100 according to an embodiment of the present invention by referring to the attached drawing.

The shock absorber 100 is a device interposed, for example, between a vehicle body and an axle shaft of a vehicle (not illustrated) for generating a damping force to reduce vibration of the vehicle body.

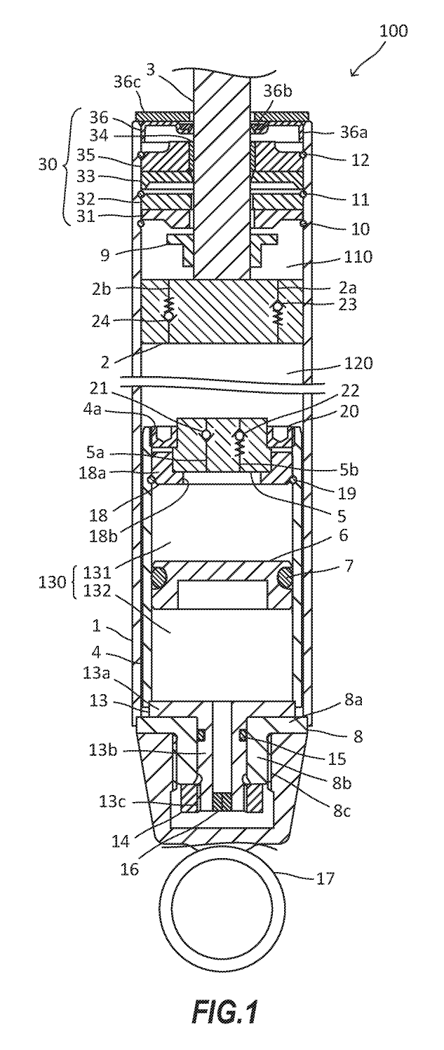

As illustrated in FIG. 1, the shock absorber 100 includes a cylinder 1, a piston 2 slidably inserted into the cylinder 1 for partitioning an inside of the cylinder 1 into an extension-side chamber 110 and a contraction-side chamber 120, a piston rod 3 inserted movably into and out of the cylinder 1 to be coupled to the piston 2, a tube 4 disposed inside the contraction-side chamber 120, a valve mechanism 5 attached to the tube 4 for partitioning a reservoir 130 inside the tube 4, and a free piston 6 slidably inserted into the tube 4 for partitioning the reservoir 130 into a liquid chamber 131 and a gas chamber 132.

In the extension-side chamber 110, the contraction-side chamber 120, and the liquid chamber 131, hydraulic oil as operating fluid is sealed. In the gas chamber 132, compressed gas is sealed. The free piston 6 has an outer periphery on which an O-ring 7 for holding air tightness in the gas chamber 132 is disposed.

The cylinder 1 has an end portion at a side of the extension-side chamber 110. On this end portion, an upper component group 30 is detachably attached. The cylinder 1 has an end portion at a side of the contraction-side chamber 120. On this end portion, a first bottom member 8 is disposed.

The upper component group 30 in this embodiment is constituted of a cushion 31 that abuts on a stopper 9 disposed on the piston rod 3 when the shock absorber 100 extends most, a plate 32 that receives load input from the piston rod 3 via the stopper 9 and the cushion 31 when the shock absorber 100 extends most, an oil seal 33 for preventing the hydraulic oil from leaking outside the shock absorber 100, a rod guide 35 that slidably supports the piston rod 3 via a bush 34, and a dust seal 36 for preventing foreign materials from being inserted into an inside of the shock absorber 100.

It should be noted that it is only necessary that the upper component group 30 includes at least the oil seal 33 and the rod guide 35, and the other components are disposed as necessary.

The cushion 31, the plate 32, the oil seal 33, and the rod guide 35 are mounted on the cylinder 1 using C-rings 10 to 12 fitted into inner peripheral grooves formed on an inner periphery of the cylinder 1.

Specifically, the cushion 31 and the plate 32 have positions in an axial direction inside the cylinder 1. These positions are specified by the C-ring 10 and the C-ring 11. The oil seal 33 and the rod guide 35 have positions in the axial direction inside the cylinder 1. These positions are specified by the C-ring 11 and the C-ring 12.

The dust seal 36 is formed such that a dust lip 36b is secured to a circular base metal 36a, which is a press forming item, by rubber vulcanization. To the base metal 36a, a plate 36c that receives load input from a bump rubber (not illustrated) when the shock absorber 100 contracts most is welded. It should be noted that a bump cap may detachably attached to the end portion of the cylinder 1 instead of providing the plate 36c on the dust seal 36.

The dust seal 36 is attached such that an outer peripheral portion of the base metal 36a is press-fitted to the inner periphery of the cylinder 1. The press-fit of the base metal 36a to the cylinder 1 is light press-fit. Accordingly, the dust seal 36 can be easily removed from the cylinder 1.

The first bottom member 8, which is circular, has a main body portion 8a having an outer periphery to which the end portion of the cylinder 1 is welded, and a tubular portion 8b formed on a center of the main body portion 8a to project outside the cylinder 1 in the axial direction.

On the first bottom member 8, a second bottom member 13 disposed on an end portion of the tube 4 is detachably attached. This secures the tube 4 to the end portion of the cylinder 1 via the first bottom member 8 and the second bottom member 13.

Specifically, the second bottom member 13, which is circular, has a main body portion 13a having an outer periphery to which the end portion of the tube 4 is welded, and a tubular portion 13b formed on a center of the main body portion 13a to project outside the tube 4 in the axial direction.

The tubular portion 13b has an outer diameter that is a dimension insertable into an inner periphery of the first bottom member 8 without rattling. The tubular portion 13b has a length set larger than an overall width in the axial direction of the first bottom member 8, as illustrated in FIG. 1. The tubular portion 13b has an outer periphery at a distal end portion. On this outer periphery, a screw portion 13c is formed.

The tube 4 is secured to the cylinder 1 such that the tubular portion 13b of the second bottom member 13 is inserted into the inner periphery of the first bottom member 8, and a lower nut 14 is screwed with the screw portion 13c.

The tubular portion 13b of the second bottom member 13 has an outer periphery on which an O-ring 15 for preventing the hydraulic oil from leaking outside the shock absorber 100 is disposed.

The second bottom member 13 has an inner periphery on which a plug 16 for filling the compressed gas in the gas chamber 132 is disposed.

The tubular portion 8b of the first bottom member 8 has an outer periphery on which a screw portion 8c is formed. With the screw portion 8c, a mounting member 17 for mounting the shock absorber 100 on a vehicle is screwed.

The valve mechanism 5 is attached to an end portion at a side opposite to the second bottom member 13 of the tube 4 to partition the reservoir 130 inside the tube 4.

Specifically, the valve mechanism 5, in a state fitted into a case 18, is attached to the cylinder 1 together with the case 18 by a C-ring 19 fitted into an inner peripheral groove formed on an inner periphery of the tube 4, and a ring nut 20 screwed with a screw portion 4a formed on the inner periphery at the end portion of the tube 4.

The case 18, which is circular, has a main body portion 18a, and a collar portion 18b formed on one end side at an inner periphery of the main body portion 18a. The valve mechanism 5 is seated on the collar portion 18b.

The main body portion 18a has an outer diameter that is a dimension insertable into the inner periphery of the tube 4 without rattling. The main body portion 18a has an inner diameter that is a dimension such that the valve mechanism 5 is fitted into the main body portion 18a without rattling.

Since the valve mechanism 5 is a standard component, its outer diameter possibly does not match an inner diameter of the tube 4. In view of this, in this embodiment, the valve mechanism 5, which is the standard component, can be attached to the tube 4 by disposing the case 18. This allows using various valve mechanisms 5, only by newly disposing the case 18.

The valve mechanism 5 has passages 5a, 5b that communicate the contraction-side chamber 120 with the liquid chamber 131.

On the passage 5a, a check valve 21 that opens when the shock absorber 100 extends to open the passage 5a is disposed.

On the passage 5b, a damping valve 22 that opens when the shock absorber 100 contracts to open the passage 5b, and applies resistance to the flow of the hydraulic oil that moves from the contraction-side chamber 120 to the liquid chamber 131 through the passage 5b is disposed.

The piston 2 has passages 2a, 2b that communicate the extension-side chamber 110 with the contraction-side chamber 120.

On the passage 2a, a damping valve 23 that opens when the shock absorber 100 extends to open the passage 2a, and applies the resistance to flow of the hydraulic oil that moves from the extension-side chamber 110 to the contraction-side chamber 120 through the passage 2a is disposed.

On the passage 2b, a damping valve 24 that opens when the shock absorber 100 contracts to open the passage 2b, and applies the resistance to the flow of the hydraulic oil that moves from the contraction-side chamber 120 to the extension-side chamber 110 through the passage 2b is disposed.

In the case where the shock absorber 100 extends when the piston rod 3 exits from the cylinder 1, the hydraulic oil moves through the passage 2a from the extension-side chamber 110 whose volume decreases such that the piston 2 moves, to the contraction-side chamber 120 whose volume expands. The hydraulic oil having a volume of the piston rod 3 that has exited from the cylinder 1 is supplied to the contraction-side chamber 120 from the liquid chamber 131 through the passage 5a, and gas inside the gas chamber 132 expands.

At this time, the shock absorber 100, as described above, applies the resistance to the flow of the hydraulic oil that passes through the passage 2a at the damping valve 23 to generate differential pressure between the extension-side chamber 110 and the contraction-side chamber 120, thus generating damping force.

In the case where the shock absorber 100 contracts when the piston rod 3 is inserted into the cylinder 1, the hydraulic oil moves through the passage 2b from the contraction-side chamber 120 whose volume decreases such that the piston 2 moves, to the extension-side chamber 110 whose volume expands. The hydraulic oil having the volume of the piston rod 3 that has been inserted into the cylinder 1 is discharged from the contraction-side chamber 120 to the liquid chamber 131 through the passage 5b, and the gas inside the gas chamber 132 is compressed.

At this time, the shock absorber 100, as described above, applies the resistance to the flow of the hydraulic oil that passes through the passages 2b, 5b at each of the damping valves 24, 22 to generate the differential pressure between the extension-side chamber 110 and the contraction-side chamber 120, thus generating the damping force.

Subsequently, the following describes an operational advantage by constituting the shock absorber 100 as described above.

In the shock absorber 100, as described above, the upper component group 30 (for example, the oil seal 33 and the rod guide 35) is attached to the cylinder 1 using the C-rings 10 to 12. In view of this, by removing the C-rings 10 to 12, the upper component group 30 can be removed from the cylinder 1. This can take the piston 2 and the piston rod 3 out from the cylinder 1. Furthermore, the valve mechanism 5 is attached to the tube 4 using the ring nut 20 and the C-ring 19. In view of this, by removing the ring nut 20 screwed with the screw portion 4a of the tube 4, the valve mechanism 5 can be removed from the tube 4. Furthermore, by removing the C-ring 19, the free piston 6 can be removed from the tube 4.

Thus, the shock absorber 100 in this embodiment has a structure that can be disassembled. Accordingly, the tuning of the damping force and the overhaul can be performed.

In the shock absorber 100, by removing the lower nut 14, the tube 4 can be removed from the cylinder 1.

According to this, when the shock absorber 100 is assembled, the tube 4 can be attached to the cylinder 1 in a state where the valve mechanism 5 and the free piston 6 have been preliminary attached to the tube 4. When the shock absorber 100 is disassembled, after the tube 4 is removed from the cylinder 1, the valve mechanism 5 and the free piston 6 can be removed from the tube 4. Accordingly, the assembly and the disassembly of the shock absorber 100 are facilitated.

The following describes the configuration, the action, and the effect according to the embodiment of the present invention as a whole.

The mono-tube shock absorber 100 includes the cylinder 1 in which the operating fluid is sealed, the piston 2 slidably inserted into the cylinder 1 to partition the inside of the cylinder 1 into the extension-side chamber 110 and the contraction-side chamber 120, the piston rod 3 inserted movably into and out of the cylinder 1 to be coupled to the piston 2, the upper component group 30 including at least the oil seal 33 and the rod guide 35 that are detachably attached to the end portion at the extension-side chamber 110 side of the cylinder 1, the tube 4 that is disposed inside the contraction-side chamber 120 and has one end secured to the end portion at the contraction-side chamber 120 side of the cylinder 1, the valve mechanism 5 detachably attached to the other end side of the tube 4 to partition the reservoir 130 inside the tube 4, and the free piston 6 slidably inserted into the tube 4 to partition the reservoir 130 into the liquid chamber 131 and the gas chamber 132.

The upper component group 30 is attached to the cylinder 1 using the C-rings 10 to 12 disposed on the inner periphery of the cylinder 1, and the valve mechanism 5 is attached to the tube 4 using the C-ring 19 disposed on the inner periphery of the tube 4, and the ring nut 20 screwed with the end portion of the tube 4.

With these configurations, the upper component group 30 can be removed from the cylinder 1, and the piston 2 and the piston rod 3 can be taken out from the cylinder 1. Furthermore, the valve mechanism 5 can be removed from the tube 4, and the free piston 6 can be taken out from the tube 4. Accordingly, the mono-tube shock absorber 100 where the valve mechanism 5 is attached to the tube 4 disposed inside the contraction-side chamber 120 can be disassembled.

The tube 4 is secured to the cylinder 1 such that the second bottom member 13 disposed on the end portion at the one end side of the tube 4 is detachably attached to the first bottom member 8 disposed on the end portion at the contraction-side chamber 120 side of the cylinder 1.

With this configuration, the tube 4 can be removed from the cylinder 1. Accordingly, when the mono-tube shock absorber 100 is assembled, the tube 4 can be attached to the cylinder 1 in the state where the valve mechanism 5 and the free piston 6 have been preliminary attached to the tube 4. When the mono-tube shock absorber 100 is disassembled, after the tube 4 is removed from the cylinder 1, the valve mechanism 5 and the free piston 6 can be removed from the tube 4. This facilitates the assembly and disassembly of the mono-tube shock absorber 100.

Embodiments of the present invention were described above, but the above embodiments are merely examples of applications of the present invention, and the technical scope of the present invention is not limited to the specific constitutions of the above embodiments.

For example, in the above-described embodiment, the hydraulic oil is used as the operating fluid. However, another liquid such as water may be used.

In the above-described embodiment, the dust seal 36 is attached to the cylinder 1 by press-fit. However, similarly to the other components in the upper component group 30, the dust seal 36 may be attached to the cylinder 1 using a C-ring.

With respect to the above description, the contents of application No. 2015-140625, with a filing date of Jul. 14, 2015 in Japan, are incorporated herein by reference.

1. A mono-tube shock absorber comprising:
a cylinder in which operating fluid is sealed;
a piston slidably inserted into the cylinder, the piston partitioning an inside of the cylinder into an extension-side chamber and a contraction-side chamber;
a piston rod movably inserted into the cylinder, the piston rod being coupled to the piston;
an upper component group that includes at least an oil seal and a rod guide, the upper component group being detachably attached to an end portion at the extension-side chamber side of the cylinder;
a tube disposed inside the contraction-side chamber, the tube having one end secured to an end portion at the contraction-side chamber side of the cylinder;
a valve mechanism detachably attached to the other end side of the tube, the valve mechanism partitioning a reservoir inside the tube; and
a free piston slidably inserted into the tube, the free piston partitioning the reservoir into a liquid chamber and a gas chamber.

2. The mono-tube shock absorber according to claim 1, wherein:
the upper component group is attached to the cylinder using C-rings disposed on an inner periphery of the cylinder, and
the valve mechanism is attached to the tube using: a C-ring disposed on an inner periphery of the tube, and a nut screwed with an end portion of the tube.

3. The mono-tube shock absorber according to claim 1, wherein
the tube is secured to the cylinder such that a second bottom member disposed on an end portion at the one end side of the tube is detachably attached to a first bottom member disposed on the end portion at the contraction-side chamber side of the cylinder.
